(19) United States
(12) Patent Application Publication
(10) Pub. No.: US 2026/0204785 A1
(43) Pub. Date: Jul. 16, 2026

(54) ELECTRONIC DEVICE INCLUDING ANTENNA

(71) Applicant: Samsung Electronics Co., Ltd., Suwon-si (KR)

(72) Inventors: Heejun LEE, Suwon-si (KR); Mincheol SEO, Suwon-si (KR); Gyubok PARK, Suwon-si (KR)

(21) Appl. No.: 19/436,381

(22) Filed: Dec. 30, 2025

Related U.S. Application Data
(63) Continuation of application No. PCT/KR2025/022812, filed on Dec. 24, 2025.

(30) Foreign Application Priority Data
Jan. 14, 2025 (KR) 10-2025-0005755
Aug. 26, 2025 (KR) 10-2025-0119693

(51) Int. Cl. H01Q 5/307; H01Q 1/24; H01Q 1/38; H01Q 15/14; H04M 1/03

(52) U.S. Cl. CPC H01Q 5/307; H01Q 1/243; H01Q 1/38; H01Q 15/14; H04M 1/03

(57) ABSTRACT

An electronic device is provided. The electronic device includes wireless communication circuitry, a frame including a side structure forming an exterior lateral side of the electronic device and a support structure disposed inwardly from the side structure, wherein the side structure includes a conductive portion at a top lateral side of the electronic device, a circuit board including at least one insulator layer and at least one ground layer, wherein a feeding portion connected to the wireless communication circuitry is formed in a region overlapping the at least one insulator layer and the at least one ground layer, wherein a radiation line portion extending from the feeding portion and connected to the conductive portion is formed in a region, overlapping only the at least one insulator layer among the at least one insulator layer and the at least one ground layer, and a metal structure disposed over the support structure of the frame, wherein the conductive portion and the radiation line portion connected to the conductive portion are configured to function as a radiator.

### CROSS-REFERENCE TO RELATED APPLICATION(S)

This application is a continuation application, claiming priority under 35 U.S.C. § 365(c), of an International application No. PCT/KR 2025/022812, filed on Dec. 24, 2025, which is based on and claims the benefit of a Korean patent application number 10-2025-0005755, filed on Jan. 14, 2025, in the Korean Intellectual Property Office, and of a Korean patent application number 10-2025-0119693, filed on Aug. 26, 2025, in the Korean Intellectual Property Office, the disclosure of each of which is incorporated by reference herein in its entirety.

### BACKGROUND

### 1. Field

The disclosure relates to an electronic device including an antenna.

### 2. Description of Related Art

An electronic device may transmit signals through an antenna or receive signals through the antenna. For example, the electronic device may include a conductive portion. The conductive portion may operate as a radiator of the antenna for transmitting and/or receiving the signals.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including an antenna.

Additional aspects will be set forth in part in the description which follows and, in part, will be apparent from the description, or may be learned by practice of the presented embodiments.

In accordance with an aspect of the disclosure, an electronic device is provided. The electronic device includes wireless communication circuitry, a frame including a side structure forming an exterior lateral side of the electronic device and a support structure disposed inwardly from the side structure, the side structure including a conductive portion at a top lateral side of the electronic device, a circuit board including at least one insulator layer and at least one ground layer, wherein a feeding portion connected to the wireless communication circuitry is formed in a region overlapping the at least one insulator layer and the at least one ground layer, wherein a radiation line portion extending from the feeding portion and connected to the conductive portion is formed in a region, overlapping only the at least one insulator layer among the at least one insulator layer and the at least one ground layer, and a metal structure disposed over the support structure of the frame, wherein the conductive portion and the radiation line portion connected to the conductive portion are configured to function as a radiator, wherein the metal structure is configured to function as a reflector for signals from the radiation line portion, and wherein the radiation line portion includes a conductive line having a longitudinal direction corresponding to a longitudinal direction of the conductive portion between the metal structure and the conductive portion.

In accordance with an aspect of the disclosure, an electronic device is provided. The electronic device includes wireless communication circuitry, a frame including a side structure forming an exterior lateral side of the electronic device and a support structure disposed inwardly from the side structure, wherein the side structure includes a conductive portion at a top lateral side of the electronic device, a circuit board including a feeding portion connected to the wireless communication circuitry and a radiation line portion extending from the feeding portion and connected to the conductive portion, and a metal structure configured to function as a reflector for signals from the radiation line portion, wherein the radiation line portion includes a conductive line having a longitudinal direction corresponding to a longitudinal direction of the conductive portion between the metal structure and the conductive portion, and wherein the conductive line of the radiation line portion is spaced apart from the metal structure by a distance greater than or equal to 0.5 millimeter (mm) and less than 1 mm.

In accordance with an aspect of the disclosure, an electronic device is provided. The electronic device includes wireless communication circuitry, a metal frame including a conductive portion, and a circuit board including a ground region for the wireless communication circuitry and a fill-cut region formed between the ground region and the conductive portion, wherein the circuit board includes a feeding portion connected to the wireless communication circuitry in the ground region and a radiation line portion extending from the feeding portion in the fill-cut region and connected to the conductive portion, wherein the electronic device includes a metal structure configured to function as a reflector in response to signals from the radiation line portion, and wherein the radiation line portion includes a conductive line having a longitudinal direction corresponding to a longitudinal direction of the conductive portion between the metal structure and the conductive portion.

In accordance with an aspect of the disclosure, an electronic device is provided. The electronic device includes wireless communication circuitry, a metal frame including a conductive portion, and a circuit board including a feeding portion connected to the wireless communication circuitry and a radiation line portion extending from the feeding portion and connected to the conductive portion, and a metal structure configured to function as a reflector in response to signals from the radiation line portion, wherein the radiation line portion includes a conductive line having a longitudinal direction corresponding to a longitudinal direction of the conductive portion between the metal structure and the conductive portion, and wherein the radiation line portion is spaced apart from the metal structure by a distance greater than or equal to 0.5 millimeter (mm) and less than 1 mm.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment.

FIG. 2A illustrates an example of an electronic device including a reflector.

FIG. 2B illustrates an example of an electronic device including an antenna.

FIG. 3A illustrates an example of an electronic device including a metal frame and a metal structure.

FIG. 3B illustrates an example of a circuit board.

FIG. 4 illustrates an example of a circuit board and a conductive portion.

FIGS. 5A and 5B indicate examples of a radiation pattern according to a distance between a radiation line portion of a circuit board and a metal structure.

FIG. 6 illustrates an example of total efficiency according to a length of a metal structure.

FIG. 7 illustrates an example of a radiation pattern according to a length of a metal structure.

FIG. 8 illustrates an example of a radiation pattern of an antenna including a radiation line portion adjacent to a metal structure.

The same reference numerals may be used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

Terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used herein, including a technical or a scientific term, may have the same meaning as those generally understood by a person with ordinary skill in the art described in the disclosure. Among the terms used in the disclosure, terms defined in a general dictionary may be interpreted as identical or similar meaning to the contextual meaning of the relevant technology and are not interpreted as ideal or excessively formal meaning unless explicitly defined in the disclosure. In some cases, even terms defined in the disclosure may not be interpreted to exclude embodiments of the disclosure.

In various embodiments of the disclosure described below, a hardware approach will be described as an example. However, since the various embodiments of the disclosure include technology that uses both hardware and software, the various embodiments of the disclosure do not exclude a software-based approach.

A term referring to a component of an electronic device (e.g., a substrate, a printed circuit board (PCB), a flexible PCB (FPCB), a printed board assembly (PBA), a module, an antenna element, circuitry, a processor, a chip, a component, or a device), a term referring to components of an antenna (e.g., an antenna radiator, a radiator, a conductive portion, a conductive line pattern, a coil, a conductive member, a radiation member, a radiation material, a radiation component, an antenna structure, an antenna construction, a feeding portion, a feeding member, a radio frequency (RF) line, a connecting member, a connecting portion, or a contact member), a term referring to a position of a component (e.g., a portion, a position, a region, or a point), a term referring to a shape of a component (e.g., a structure, a construction, a support portion, a contact portion, a flange, or a protrusion), a term referring to a connection between structures (e.g., connecting unit, a connecting portion, a contact unit, a contact portion, a support, a support portion, a connecting structure, a support structure, a contact structure, a conductive member, a conductive pad, a conductive pattern, or an assembly), a term referring to an open structure (e.g., a slot, a slit, or an opening), a term referring to circuitry (e.g., a PCB, a FPCB, a signal line, a ground line, a feeding line, a data line, a RF signal line, an antenna line, an RF path, an RF module, RF circuitry, a splitter, a divider, a coupler, or a combiner), and the like used in the following descriptions are exemplified for convenience of description. Therefore, the disclosure is not limited to terms to be described below, and another term having an equivalent technical meaning may be used. In addition, a term such as ‘ . . . unit’, ‘ . . . device’, ‘ . . . object’, and ‘ . . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}. In addition, a meaning of ‘approximately E’ may be replaced with a value within an error range of ±5% or ±10% based on E.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

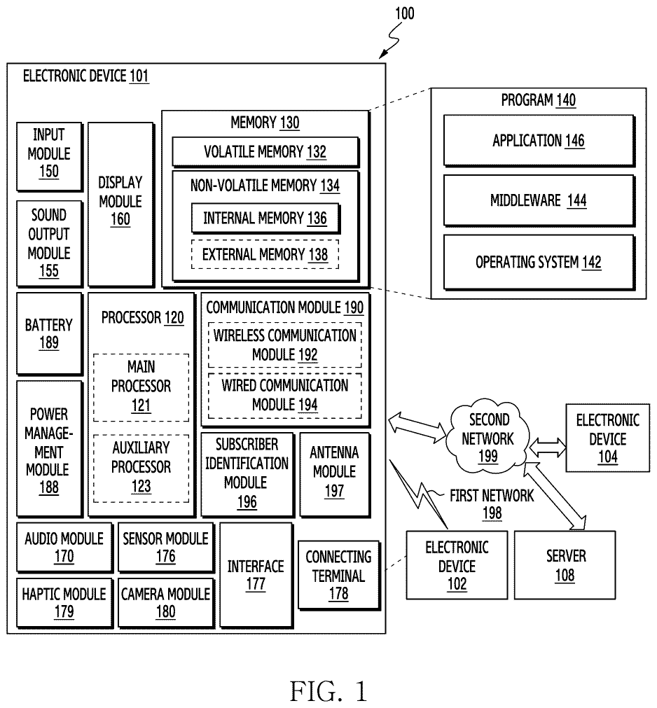

FIG. 1 is a block diagram of an electronic device in a network environment.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102, 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

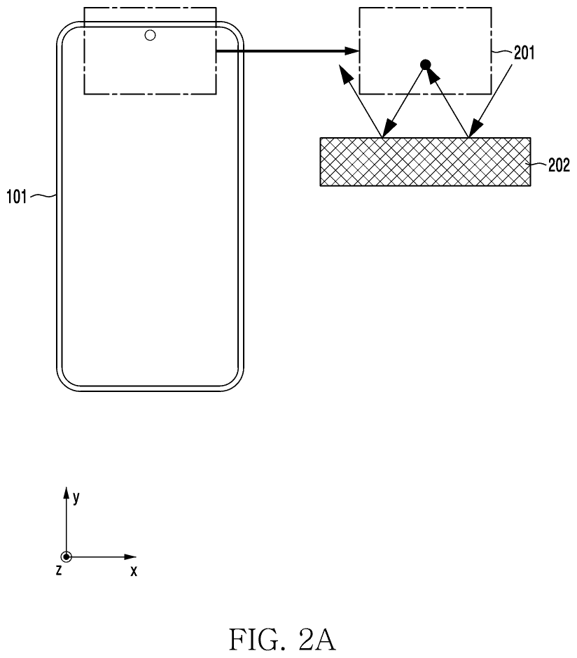

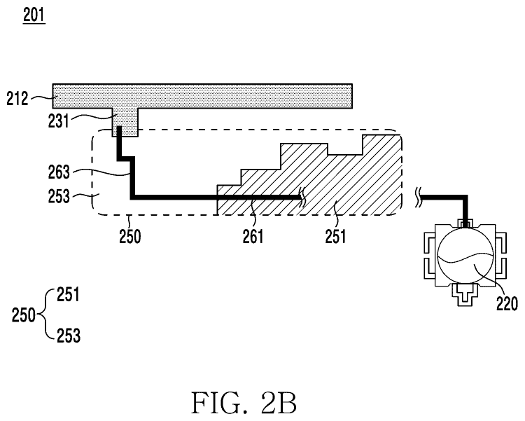

FIG. 2A illustrates an electronic device (e.g., an electronic device 101) including a reflector.

Referring to FIG. 2A, the electronic device 101 may use an antenna. For a specific service (e.g., a satellite service), satisfaction of a specific metric (e.g., total radiated power (TRP)/total isotropic sensitivity (TIS), effective isotropic radiated power or equivalent isotropic radiated power (EIRP)/effective isotropic sensitivity (EIS) at a specific angle, upper hemispheric radiated power (UHRP), and/or upper hemispheric isotropic sensitivity (UHIS) viewing upper hemisphere performance) may be required. For example, the electronic device 101 may perform satellite communication. The electronic device 101 may use an antenna 201 disposed at a top side of the electronic device 101 to secure radiation performance (e.g., upper hemisphere directivity) in a required upper hemisphere. The antenna 201 may support a frequency band for the satellite communication. As an example without limitation, a radiator of the antenna 201 may function as an antenna radiator for multiple bands. For example, at least a portion of the antenna 201 may be used for both a frequency band for the satellite communication and a frequency band (e.g., a mid band (MB) (e.g., a frequency band greater than or equal to approximately 1 gigahertz (GHz) and less than 2.3 GHz), a high band (HB) (e.g., a frequency band greater than or equal to approximately 2.3 GHz), and/or other NR frequency bands) for cellular communication.

The electronic device 101 may include an electrical material providing a ground. The antenna 201 may radiate a signal and the electrical material may function as the ground. The electrical material close to the antenna 201 may affect radiation performance of the antenna 201. In order to reduce an influence of the electrical material, methods of applying a ground contact to the antenna or disposing a ground wall between the antenna and the electrical material may be used. However, the methods may be difficult to design a structure for controlling the radiation performance (e.g., the upper hemisphere directivity) in the upper hemisphere. To reduce this problem, according to embodiments of the disclosure, the electronic device 101 may include a metal structure 202 spaced apart from the antenna 201 by a predetermined distance. Isolation may be secured through the antenna 201 spaced apart from the metal structure 202 by the predetermined distance. The metal structure 202 may correspond to the electrical material (e.g., steel use stainless (SUS), a camera bracket, and an enclosure of a speaker module (e.g., of the sound output module 155)) providing the ground. Meanwhile, the specific service (e.g., the satellite service) requires high radiation performance (e.g., the upper hemisphere directivity) in the upper hemisphere. In order to increase the upper hemisphere directivity, the metal structure 202 may function as a reflector with respect to the antenna 201. In the disclosure, based on a separation distance between a portion of the antenna 201 and the metal structure 202, a technique for increasing a directivity (e.g., the upper hemisphere directivity) of the antenna required by the specific service (e.g., the satellite service) is described.

FIG. 2B illustrates an electronic device (e.g., an electronic device 101) including an antenna (e.g., an antenna 201). In FIG. 2B, a structure of an antenna 201 corresponding to a metal structure 202 functioning as a reflector is described. The same reference numbers may be used for the same descriptions.

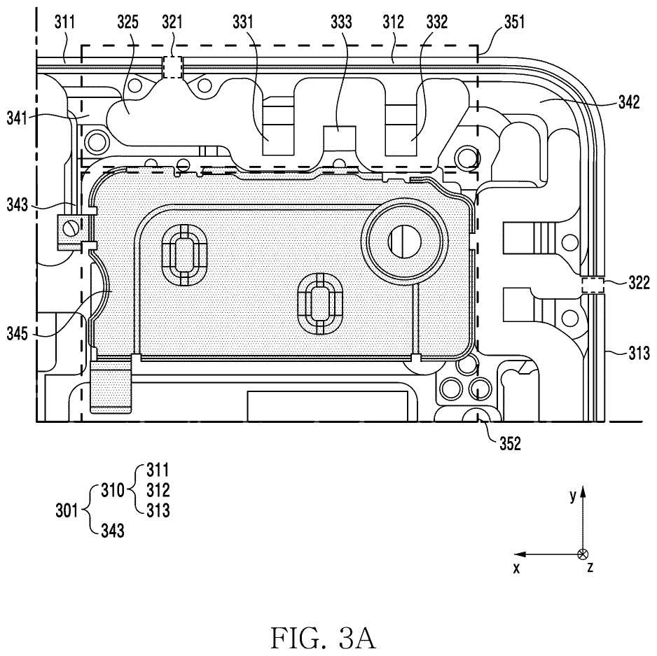

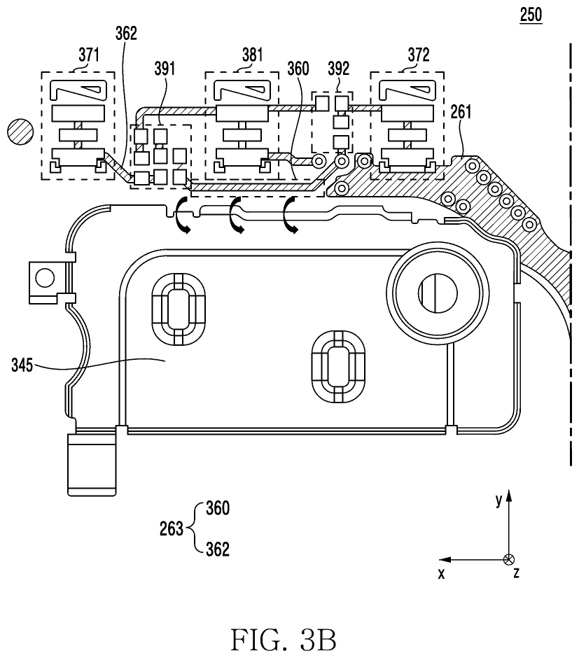

Referring to FIG. 2B, the electronic device 101 may include a conductive portion 212. For example, the conductive portion 212 may be a portion of a side structure (e.g., the side structure 310 of FIGS. 3A and 3B) that forms an exterior lateral side of the electronic device 101 among a metal frame (e.g., a metal frame 301 of FIGS. 3A and 3B). According to an embodiment of the disclosure, the conductive portion 212 may be used as a radiator for an antenna. The electronic device 101 may transmit a signal or receive a signal through the conductive portion 212. The electronic device 101 may include wireless communication circuitry 220. According to an embodiment of the disclosure, the wireless communication circuitry 220 may be configured to transmit signals in a frequency band of satellite communication. For example, the frequency band may be an S-band (transmission: 1.98 GHz to 2.01 GHz, and reception: 2.17 GHz to 2,20 GHz). The S-band may be used for a mobile satellite service (MSS). In order to use the conductive portion 212 as a radiator for the signals of the wireless communication circuitry 220, a structure for feeding an RF signal (hereinafter, a feeding structure) may be disposed between the conductive portion 212 and the wireless communication circuitry 220.

The electronic device 101 may include a circuit board 250. The circuit board 250 may include a plurality of layers. For example, the circuit board 250 may be a rigid printed circuit board (PCB) or a flexible printed circuit board (FPCB). As an example, the circuit board 250 may be a flexible RF cable (FRC) corresponding to the FPCB. The circuit board 250 may include a ground region 251. When the circuit board 250 is viewed in a direction (e.g., a (−)z-axis direction), the ground region 251 may indicate a region in which a conductor portion (e.g., a copper portion) is formed for transmitting a ground of one or more electronic components (e.g., the wireless communication circuitry 220) of the electronic device 101. For example, the conductor portion may provide the ground by being connected to the wireless communication circuitry 220. In other words, the ground region 251 may indicate a region having a ground plane above or below in the circuit board 250. For example, in the ground region 251, at least a portion of the plurality of layers of the circuit board 250 may include a copper layer for providing the ground and/or transmitting a signal. An insulator layer (e.g., pre-impregnated (PPG)) may be disposed between copper layers. In the ground region 251, the copper layer and the insulator layer may be stacked together. Circuitry corresponding to the copper portion may be formed in the ground region 251 of the circuit board 250. For example, a chip, a device, and/or an element for the electronic device 101 may be disposed on the ground region 251. For example, the wireless communication circuitry 220 (e.g., the communication module 190) may be disposed on the ground region 251. At least a portion of the wireless communication circuitry 220 may be disposed in the ground region 251 of the circuit board 250. For example, the wireless communication circuitry 220 may include an RF transceiver and/or a radio frequency front end (RFFE) module. A portion of the wireless communication circuitry 220 may be referred to as feeding circuitry in terms of providing an antenna feeding. As an example, the feeding circuitry may be referred to as a feeding unit as a source for the antenna feeding. As an example without limitation, the wireless communication circuitry 220 may include an RF switching circuit connected to the RFFE module. As an example, an output port of the RF switching circuit may be referred to as a feeding unit as a source of an RF signal. The feeding unit may provide a conductive portion 203 with a signal to through a feeding structure.

The circuit board 250 may include a signal region 253. When the circuit board 250 is viewed in the direction (e.g., the (−)z-axis direction), the signal region 253 may not overlap the ground region 251. For example, the signal region 253 may be positioned outside the ground region 251 overlapping the at least one insulator layer and the at least one ground layer. According to an embodiment of the disclosure, the signal region 253 may be a region used to transmit a signal to a metal frame 200 (e.g., the conductive portion 203). The circuit board 250 may include the plurality of layers. The circuit board 250 may include at least one insulator layer and at least one conductive layer (e.g., the copper layer). The at least one conductive layer may include a layer used for transmitting a signal (hereinafter, a signal transmission layer) and a layer on which the ground plane (hereinafter, a ground layer) is formed. The at least one conductive layer may include one or more signal transmission layers and/or one or more ground layers. In the circuit board 250, the ground region 251 may indicate a portion of a signal transmission layer overlapping the at least one insulator layer and the at least one ground layer. In other words, when the circuit board 250 is viewed in the direction (e.g., the (−)z-axis direction), the ground region 251 may indicate a region in which a conductor portion (e.g., the copper portion) is formed to transmit a ground of one or more electronic components (e.g., the wireless communication circuitry 220) of the electronic device 101. On the other hand, the signal region 253 in the circuit board 250 may indicate a region overlapping only the at least one insulator layer among the at least one insulator layer and the at least one ground layer. The signal region 253 may be referred to in various terms. In terms of overlapping only the insulator layer, the signal region 253 may be referred to as a non-copper region, a non-ground region, a clearance region, a ground clearance region, a ground keep out region, a ground void region, an RF clearance region, a ground relief region, and/or an equivalent technical term. The signal region 253 may indicate a region in which the conductor portion (e.g., a copper portion for providing a ground) of the ground region 251 is removed between the metal frame 200 (e.g., the conductive portion 203) and the ground region 251 of the circuit board 250. In terms of being removed, the signal region 253 may be referred to as a fill-cut region, a copper removal region, a keep-out region, a cut-out region, and/or an equivalent technical term. However, use of this term is not interpreted as limiting a manufacturing process or an implementation method of the circuit board 250. For example, the signal region 253 may not include the copper portion for the ground. In the signal region 253, the circuit board 250 may include insulator layers (e.g., dielectric layers) without the copper portions. In other words, the ground region 251 may indicate a region having no ground plane above or below in the circuit board 250.

The circuit board 250 may have a feeding structure between the wireless communication circuitry 220 and the conductive portion 212. The circuit board 250 may include a feeding portion 261 in the ground region 251 and a radiation line portion 263 in the signal region 253. The feeding portion 261 may include a signal line including a ground around it. The radiation line portion 263 may include a conductive line disposed on some of a plurality of insulator layers, wherein the plurality of insulator layers are stacked for signal transmission in the signal region 253. The radiation line portion 263 may be electrically connected to a conductive member (e.g., a C-clip, or a conductive pattern). The conductive member may be disposed on one surface of the circuit board 250. The conductive member may be disposed to be in contact with a protruding portion 231 of the conductive portion 212 or a component connected to the protruding portion 231. Due to the contact, an RF signal from the wireless communication circuitry 220 and the feeding portion 261 may be provided to the conductive portion 212. The conductive portion 212 may be configured to radiate the RF signal.

According to embodiments of the disclosure, in order to increase upper hemisphere directivity, an electrical material (e.g., the metal structure 202) may be used as a reflector. A radiator may be required to be disposed adjacent to the electrical material (e.g., the metal structure 202). According to an embodiment of the disclosure, the radiation line portion 263 may function as a radiator for the RF signal of the wireless communication circuitry 220. Since there is no ground for shielding a signal or reducing noise around the radiation line portion 263, the radiation line portion 263 may be configured to radiate as well as feed a signal. In other words, the radiation line portion 263 may function as the radiator. Both the radiation line portion 263 and the conductive portion 212 may be used as the radiator. For example, the conductive portion 212 may be used for a plurality of frequency bands. In a frequency band (e.g., a frequency band for cellular communication) different from a communication frequency band (e.g., an S-band for satellite communication) provided through the wireless communication circuitry 220, the conductive portion 212 may be disposed to be sufficiently spaced apart from the electrical material so that signals of the conductive portion 212 are not affected by the electrical material (e.g., the metal structure 202). In order to use the metal structure 202 as the reflector, the radiation line portion 263 different from the conductive portion 212 may be used as a radiator for the communication frequency band (e.g., the S-band for the satellite communication).

According to an embodiment of the disclosure, the radiation line portion 263 may include a conductive line having a longitudinal direction corresponding to a longitudinal direction of the conductive portion 212. For example, the conductive portion 212 may be disposed to face in a direction (e.g., a top side direction of the electronic device 101). Signals radiated from the conductive line may be reflected through a reflector. The longitudinal direction of the conductive line may correspond to the longitudinal direction of the conductive portion 212 so that the reflective direction corresponds to the direction. As example without limitation, the longitudinal direction of the conductive line may be substantially parallel to the longitudinal direction of the conductive portion 212. Referring to both FIGS. 2A and 2B, the radiation line portion 263 may be disposed between the conductive portion 212 and the electrical material (e.g., the metal structure 202). According to an embodiment of the disclosure, the radiation line portion 263 may be formed by being spaced apart from the metal structure 202 along one side of the metal structure 202 toward the top side of the electronic device 101. For example, the conductive line may be spaced apart from one side of the metal structure 202 to have a predetermined range (e.g., more than or equal to approximately 5 mm and less than approximately 10 mm).

In FIG. 2B, the feeding portion 261 and the radiation line portion 263 are illustrated as a continuous conducting wire in one layer, but embodiments of the disclosure are not limited thereto. For example, the feeding portion 261 and the radiation line portion 263 may be disposed in different layers within the circuit board 250. As an example, an end of the feeding portion 261 may be electrically connected to an end of the radiation line portion 263 through a conductive via.

In FIG. 2B, the conductive portion 212 of a metal frame as the radiator of the antenna 201 is described as an example, but embodiments of the disclosure are not limited thereto. The conductive portion 212 may be a different type of radiator. For example, a patch radiator connected to the radiation line portion 263 may be understood as a type of the conductive portion 203. For another example, a coil radiator connected to the radiation line portion 263 may be understood as a type of the conductive portion 212.

In FIG. 2B, an example in which there is no ground layer in the signal region 253 of the circuit board 250 is illustrated when the circuit board 250 is viewed in the direction (e.g., in the (−)z-axis direction), but as an example without limitation, the ground layer of the circuit board 250 may be disposed sufficiently spaced apart from the radiation line portion 263.

FIG. 3A illustrates an example of an electronic device (e.g., an electronic device 101) including a metal frame (e.g., a metal frame including a conductive portion 212) and a metal structure (e.g., the metal structure 202). The same reference numbers may be used for the same descriptions.

Referring to FIG. 3A, the electronic device 101 may include a metal frame 301. The metal frame may include a side structure 310 and a support structure 343 connected to the side structure 310. For example, the support structure 343 may be formed by extending inward from the side structure 310. The side structure 310 may include a plurality of conductive portions. For example, the side structure 310 may include a first conductive portion 311, a second conductive portion 312, and a third conductive portion 313. The side structure 310 may be connected to the support structure 343 through a plurality of connecting portions. For example, the plurality of connecting portions may include a first connecting portion 341 and a second connecting portion 342. The first conductive portion 311 may be connected to the support structure 343 through the first connecting portion 341. The second conductive portion 312 may be connected to the support structure 343 through a second connecting portion 342. The support structure 343 may be disposed to support a component (e.g., a display) in the electronic device 101. The support structure 343 may be used to provide a ground. For example, the support structure 343 may include a protruding portion 333 connected to the ground.

A non-conductive portion may be disposed between conductive portions of the side structure 310. For example, a first non-conductive portion 321 may be disposed between the first conductive portion 311 and the second conductive portion 312. A second non-conductive portion 322 may be disposed between the second conductive portion 312 and the third conductive portion 313. The non-conductive portion may be positioned in outer periphery of the electronic device 101. As an example without limitation, the non-conductive portion may be viewed from the outside. The non-conductive portion may be referred to as a segmental portion. The side structure 310 and the support structure 343 of the metal frame 301 may form a space. For example, the metal frame 301 may have a slit 325 (or referred to as an open-ended slot). The inside of the electronic device 101 except for the metal frame 301 may be filled with a dielectric material. A portion of the dielectric material may occupy a space of the slit 325. The portion of the dielectric material filled in the slit 325 may correspond to the first non-conductive portion 321.

According to an embodiment of the disclosure, the second conductive portion 312 may be used as a radiator for communication (e.g., satellite communication and/or cellular communication). For example, the second conductive portion 312 may be referred to as the radiator of the antenna 201 of FIG. 2A and the conductive portion 212 of FIG. 2B. The second conductive portion 312 may have a shape for a feeding structure of a circuit board (e.g., a circuit board 250). The second conductive portion 312 may have one or more protruding portions. For example, the second conductive portion 312 may have a first protruding portion 331 and a second protruding portion 332. The first protruding portion 331 may be electrically connected to the feeding structure of the circuit board 250. The first protruding portion 331 may be referred to as the protruding portion 231 of FIG. 2B. According to an embodiment of the disclosure, the second conductive portion 312 may be used as a radiator for a plurality of frequency bands. The plurality of frequency bands may include a frequency band for the satellite communication and a frequency band for the cellular communication (e.g., LTE, or NR). For example, the frequency band for the satellite communication may include an S-band (transmission: 1.98 GHz to 2.01 GHz, and reception: 2.17 to 2,20 GHz) and/or a L1-band (greater than or equal to approximately 1563.42 megahertz (MHz) and less than approximately 1587.42 MHz, and a center frequency: approximately 1575.42 MHz). For example, the frequency band for the cellular communication may include a frequency band of a mid-band (MB) greater than or equal to approximately 1 GHz or and less than 2.3 GHz and/or a frequency band of a high-band (HB) greater than or equal to approximately 2.3 GHz. For example, the first protruding portion 331 may be electrically connected to a feeding structure for the frequency band for the satellite communication. The second protruding portion 332 may be electrically connected to a feeding structure for the frequency band for the cellular communication.

According to embodiments of the disclosure, the electronic device 101 may include a feeding structure for increasing an antenna directivity. For example, the electronic device 101 may use a reflector to increase a directivity in a direction (e.g., a (+) y-axis direction). A reflector indicates a metallic structure used to concentrate electromagnetic waves in a specific direction. The reflector may be used to improve a radiation pattern or increase directivity. According to an embodiment of the disclosure, the electronic device 101 may use SUS 345 of a speaker module (e.g., the sound output module 155) as a reflector. For the SUS 345, the metal structure 202 of FIG. 2A may be referred to. Meanwhile, since the SUS 345 may function as a ground, the SUS 345 may be required to be spaced apart from a radiator by a predetermined distance or more. As an example, the SUS 345 may be required to be spaced apart from the second conductive portion 312 by a predetermined distance or more. In order to use the SUS 345 as the reflector, a radiator may be disposed between the second conductive portion 312 and the SUS 345. According to an embodiment of the disclosure, a portion (e.g., the radiation line portion 263 of FIG. 2B) of a feeding structure of the circuit board (e.g., the circuit board 250) may be used as the radiator.

The electronic device 101 may perform a predefined service (e.g., a satellite communication service). The predefined service may require high upper hemisphere directivity. In order to increase the upper hemisphere directivity, the second conductive portion 312 and the SUS 345 having a radiation direction in a top side direction (e.g., the (+)y-axis direction) may be used. For example, as signals of the radiation line portion 263 of the circuit board 250 are reflected by the SUS 345, the signals may be propagated in the top side direction (e.g., the (+) y-axis direction). The electronic device 101 may provide the predefined service through signals of the second conductive portion 312, signals of the radiation line portion 263, and/or signals reflected by the SUS 345. An example of the feeding structure of the circuit board 250 for using the SUS 345 as the reflector is described in detail through FIG. 3B.

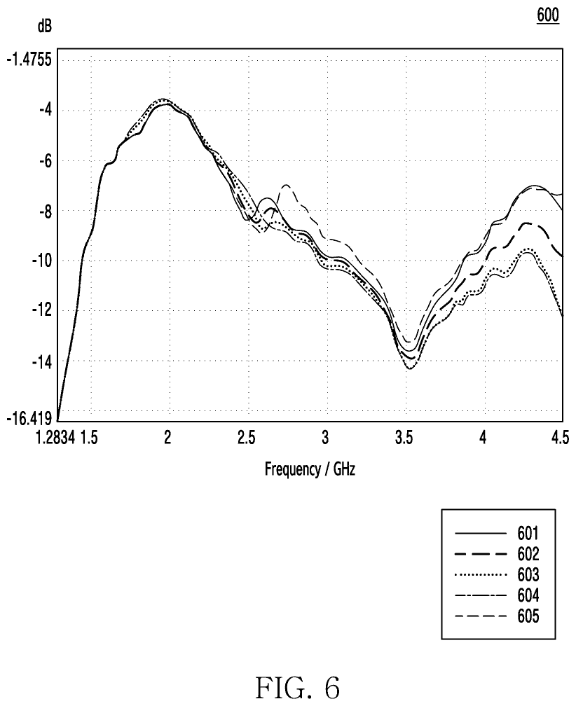

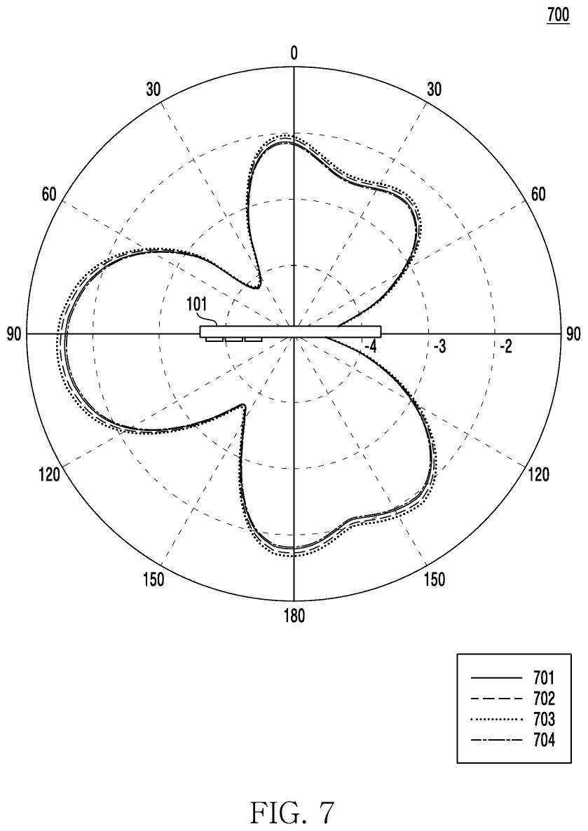

In order to describe an influence of the metal frame 301 due to the SUS 345, an antenna structure region 351 and a ground structure region 352 may be defined. According to an embodiment of the disclosure, the antenna structure region 351 may be defined based on signals radiated through a portion (e.g., the second conductive portion 312) of the metal frame 301. For example, the antenna structure region 351 may correspond to a conductive region surrounding the slit 325. A region including a metal structure (e.g., the SUS 345) that serves as a reflector may be defined as the ground structure region 352. Assume that each of an antenna structure configured to radiate signals and a ground structure for providing a ground has a longitudinal direction in the same direction (e.g., an x-axis direction). In a case that an area of the ground structure is insufficient, it may be difficult to form an intended radiation pattern using the antenna structure. According to an embodiment of the disclosure, based on a direction (e.g., the x-axis direction), a difference between a length of the antenna structure region 351 and a length of the ground structure region 352 may be less than a threshold distance (e.g., approximately 2 mm). As an example, the length of the antenna structure region 351 may be approximately 22.4 mm. The length of the ground structure region 352 may be approximately 23.8 mm. Examples of the threshold distance are described in detail with reference to FIGS. 6 and 7.

FIG. 3B illustrates an example of a circuit board (e.g., a circuit board 250). The same reference numbers may be used for the same descriptions.

Referring to FIG. 3B, an electronic device 101 may include the circuit board 250. The circuit board 250 may include a feeding portion 261 in a ground region 251 and a radiation line portion 263 in a signal region 253. For each of the ground region 251 and the signal region 253, the descriptions of FIG. 2B may be referred to. The feeding portion 261 may include a signal line including a ground around it. The radiation line portion 263 may include a conductive line disposed on some (e.g., a top insulator layer) of a plurality of insulator layers, wherein the plurality of insulator layers are stacked for signal transmission in the signal region 253.

According to embodiments of the disclosure, the radiation line portion 263 may function as a radiator for an RF signal of wireless communication circuitry 220. According to an embodiment of the disclosure, the radiation line portion 263 may include a conductive line 360 and a conductive line 362. The electronic device 101 may include a feeding structure for transmitting the RF signal from the wireless communication circuitry 220 to the second conductive portion 312. The circuit board 250 may include a conductive line 360, a first matching portion 391, a conductive line 362, and a first contact portion 371. The first matching portion 391 may include one or more passive elements (or lumped elements) (e.g., an inductor and a capacitor). The one or more elements may be used for impedance matching. The first matching portion 391 may be connected to a ground portion 381 of the circuit board 250. The ground portion 381 of the circuit board 250 may be connected to a structure (e.g., a support structure 343) for a ground in the electronic device 101. The conductive line 362 may connect the first matching portion 391 to the first contact portion 371. In the first contact portion 371, a conductive member (e.g., a C-clip, a conductive pattern, or a conductive structure) electrically connected to the second conductive portion 312 may be disposed. The RF signal from the wireless communication circuitry 220 may be provided to the second conductive portion 312 through a contact between the conductive member and a portion (e.g., the first protruding portion 331) of the second conductive portion 312. The contact point may be referred to as a feeding point.

According to an embodiment of the disclosure, the second conductive portion 312 may be used as a radiator for another frequency band (e.g., an L1 band, a MB frequency band, a HB frequency band, and/or other NR frequency bands) (hereinafter, a second frequency band) other than a frequency band (e.g., an S-band for satellite communication) (hereinafter, a first frequency band) supported in the wireless communication circuitry 220. The electronic device 101 may include a feeding structure for transmitting an RF signal from the second frequency band to the second conductive portion 312. The circuit board 250 may include a second contact portion 372 and a second matching portion 392. The second matching portion 392 may include one or more passive elements (or concentrated elements) (e.g., an inductor and a capacitor). The one or more elements may be used for impedance matching. The second matching portion 392 may be connected to the ground portion 381 of the circuit board 250. In the second contact portion 372, a conductive member (e.g., a C-lip, a conductive pattern, or a conductive structure) electrically connected to the second conductive portion 312 may be disposed. The RF signal of the second frequency band may be provided to the second conductive portion 312 through a contact between the conductive member and a portion (e.g., the second protruding portion 332) of the second conductive portion 312. The contact point may be referred to as a feeding point.

According to embodiments of the disclosure, the radiation line portion 263 may function as a radiator for a predefined service (e.g., a satellite communication service). SUS 345 may be used to increase upper hemisphere directivity. As signals of the radiation line portion 263 of the circuit board 250 are reflected by the SUS 345, the signals may be propagated in a top side direction (e.g., a (+) y-axis direction). According to embodiments of the disclosure, the radiation line portion 263 may include the conductive line 360 having a longitudinal direction in a direction (e.g., an x-axis direction) between a metal structure (e.g., the SUS 345) and a conductive portion (e.g., the second conductive portion 312). According to embodiment of the disclosure, the conductive portion 212 may be disposed to face in a direction (e.g., a top side direction of the electronic device 101). Signals radiated from the conductive line 360 may be reflected through the metal structure (e.g., the SUS 345). The longitudinal direction of the conductive line 360 may correspond to a longitudinal direction of the conductive portion 212 so that the reflected direction corresponds to the direction (e.g., the top side direction of the electronic device 101). According to an embodiment of the disclosure, the radiation line portion 263 may be formed to be spaced apart from the SUS 345 along one side (e.g., one or more planes corresponding to an xz plane) of the SUS 345 facing the top side of the electronic device 101. The conductive line 360 may be formed along a surface of the SUS 345 positioned in a region of a side opposite to a region of a side where the conductive portion 212 is positioned. As an example without limitation, the longitudinal direction of the conductive line 360 may be substantially parallel to one side of the SUS 345.

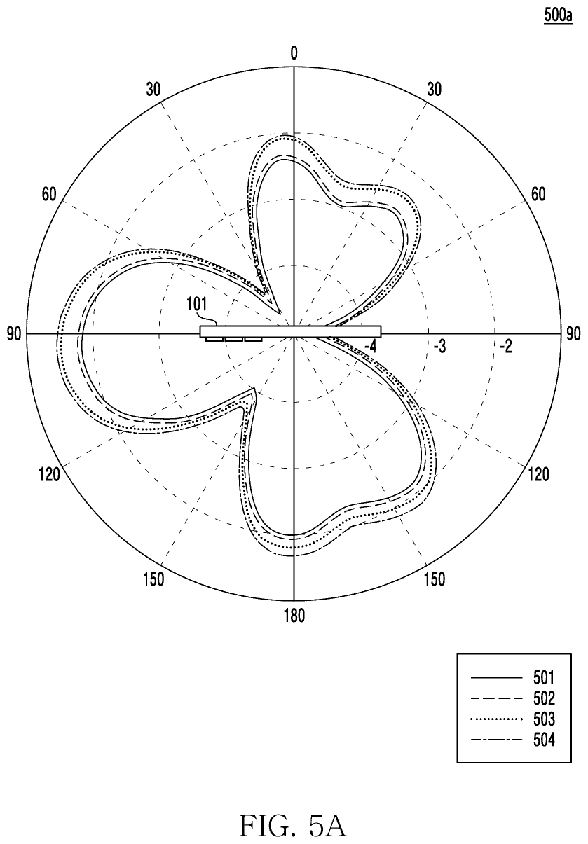

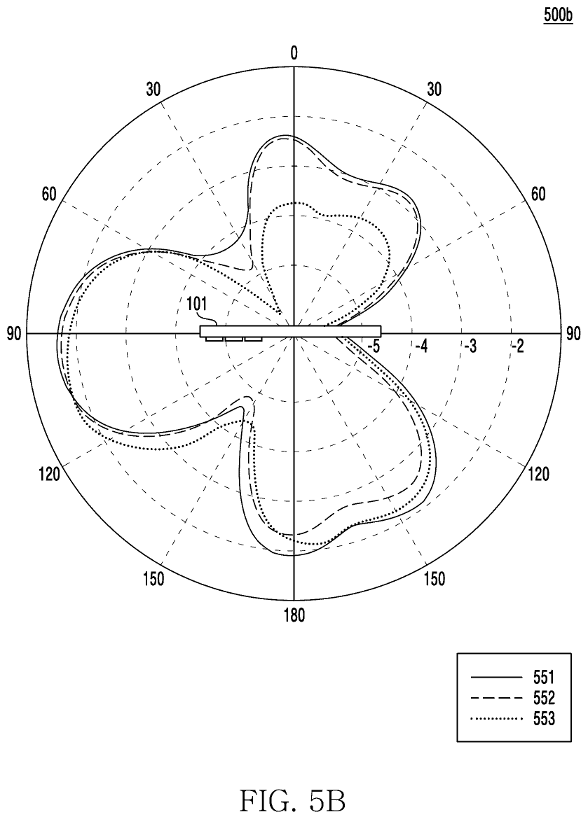

The radiation line portion 263 may be a portion of the feeding structure for transmitting the RF signal (in other words, the RF signal of the first frequency band (e.g., the S-band for satellite communication) of the wireless communication circuitry 220 to the second conductive portion 312. The conductive line 360 of the radiation line portion 263 may correspond to a conductive portion positioned closest to the SUS 345 among conductive portions (e.g., copper portions) in the signal region 253 of the circuit board 250. As an example without limitation, a separate structure that provides a ground may not be disposed between the radiation line portion 263 including the conductive line 360 and the SUS 345. The conductive line 360 may correspond to a radiation source, and the SUS 345 may correspond to a reflector. As a distance between the radiation source and the reflector increases, an amount of signals reflected through the reflector may decrease. Conversely, as the distance between the radiation source and the reflector is closer, the amount of signals reflected through the reflector may increase. However, if the distance between the radiation source and the reflector is less than a threshold distance, a signal from the radiation source is rather transmitted to a ground, so that the amount of reflected signals may be decreased. Based on characteristics of the distance between the radiation source and the reflector, a distance between the SUS 345 and the conductive line 360 may be determined. According to an embodiment of the disclosure, the distance between the conductive line 360 and the SUS 345 may be greater than or equal approximately 0.5 mm and less than approximately 1.0 mm. Radiation performance according to the distance between the conductive line 360 and the SUS 345 will be described in details through FIGS. 5A and 5B.

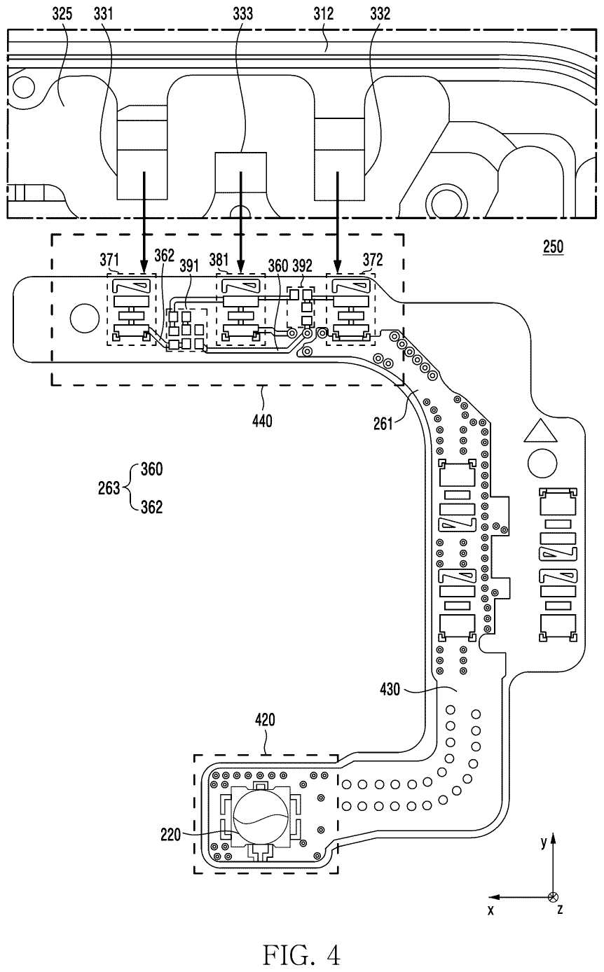

FIG. 4 illustrates an example of a circuit board (e.g., a circuit board 250) and a conductive portion (e.g., a conductive portion 212 or a second conductive portion 312). The same reference numbers may be used for the same descriptions.

Referring to FIG. 4, an electronic device 101 may include a circuit board 250. The circuit board 250 may include a first region 420 connected to wireless communication circuitry 220, a second region 430 extending from the first region 420 and including a signal line for transmitting an RF signal from the wireless communication circuitry 220, and a third region 440 extending from the second region 430 and having a feeding structure for a radiator. The first region 420 may be referred to as a component region, a signal source region, and/or an equivalent technical or structural term. The second region 430 may be referred to as a connecting region, a cable region, and/or an equivalent technical or structural term. The third region 440 may be referred to as a feeding region, an antenna region, a radiation region, and/or an equivalent technical or structural term.

According to embodiments of the disclosure, a radiation line portion 263 of the third region 440 may function as a radiator for the RF signal of the wireless communication circuitry 220. In other words, the radiation line portion 263 may be a portion of a feeding structure for transmitting the RF signal (in other words, an RF signal of a first frequency band (e.g., an S-band for satellite communication) of the wireless communication circuitry 220 to the second conductive portion 312. According to an embodiment of the disclosure, the radiation line portion 263 may include a conductive line 360 and a conductive line 362. The conductive line 360 may have a longitudinal direction in a direction (e.g., an x-axis direction) between a metal structure (e.g., SUS 345) and a conductive portion (e.g., the second conductive portion 312).

In addition to the radiation line portion 263, the circuit board 250 may include components for using the second conductive portion 312 as a radiator. The second conductive portion 312 may be used as a radiator for a plurality of frequency bands. The plurality of frequency bands may include a frequency band for satellite communication and a frequency band for cellular communication (e.g., LTE, or NR). The circuit board 250 may include a first contact portion 371 and a first matching portion 391 for the first frequency band (e.g., the S-band for the satellite communication) among the plurality of frequency bands. According to an embodiment of the disclosure, the first contact portion 371 may be connected to a first protruding portion 331 of the second conductive portion 312. For example, a conductive member disposed on the first contact portion 371 of the circuit board 250 may be in contact with the first protruding portion 331. The circuit board 250 may include a second contact portion 372 and a second matching portion 392 for a second frequency band (e.g., the frequency band for the cellular communication) among the plurality of frequency bands. According to an embodiment of the disclosure, the second contact portion 372 may be connected to a second protruding portion 332 of the second conductive portion 312. For example, a conductive member disposed on the second contact portion 372 of the circuit board 250 may be in contact with the second protruding portion 332. A ground portion 381 of the circuit board 250 may be connected to a protruding portion 333 of a support structure 343. For example, a conductive member disposed on the ground portion 381 of the circuit board 250 may be in contact with the protruding portion 333.

In FIG. 4, an example in which the wireless communication circuitry 220 is disposed on the circuit board 250 is illustrated, but embodiments of the disclosure are not limited thereto. It may be understood that an embodiment of the disclosure is also applicable to circuitry in which a PCB and the circuit board 250 are electrically connected, wherein the wireless communication circuitry 220 is separately disposed on the PCB.

FIGS. 5A and 5B illustrate examples of a radiation pattern according to a distance between a radiation line portion (e.g., a radiation line portion 263 or a conductive line 360) of a circuit board (e.g., a circuit board 250) and a metal structure (e.g., a metal structure 202 or a metal structure 345). The same reference numbers may be used for the same descriptions.

Referring to FIG. 5A, an example 500a illustrates a radiation pattern according to a distance between a radiator (e.g., the radiation line portion 263 or the conductive line 360) and a reflector (e.g., the metal structure 202 or the SUS 345). 0° indicates a front direction of an electronic device 101 and 180° indicates a rear direction of the electronic device 101. 90° on a left side indicates a top side of the electronic device 101 and 90° on a right side indicates a bottom side of the electronic device 101. A first line 501 indicates a radiation pattern when a distance between the conductive line 360 and the SUS 345 is approximately 0.1 mm. A second line 502 indicates a radiation pattern when the distance between the conductive line 360 and the SUS 345 is approximately 0.3 mm. A third line 503 indicates a radiation pattern when the distance between the conductive line 360 and the SUS 345 is approximately 0.5 mm. A fourth line 504 indicates a radiation pattern when the distance between the conductive line 360 and the SUS 345 is approximately 1.0 mm. Comparing the first line 501, the second line 502, the third line 503, and the fourth line 504, it may be confirmed that a gain (hereinafter, a boresight gain) in a top side direction of the radiation pattern of the electronic device 101 decreases, as the distance between the radiator and the reflector approaches from approximately 0.1 mm to approximately 1.0 mm.

Referring to FIG. 5B, an example 500b illustrates a radiation pattern according to a distance between a radiator (e.g., the radiation line portion 263 or the conductive line 360) and a reflector (e.g., the metal structure 202 or the SUS 345). 0° indicates a front direction of the electronic device 101 and 180° indicates a rear direction of the electronic device 101. 90° on a left side indicates a top side of the electronic device 101 and 90° on a right side indicates a bottom side of the electronic device 101. A first line 551 indicates a radiation pattern when a distance between the conductive line 360 and the SUS 345 is approximately 1.0 mm. A second line 552 indicates a radiation pattern when the distance between the conductive line 360 and the SUS 345 is approximately 1.5 mm. A third line 553 indicates a radiation pattern when the distance between the conductive line 360 and the SUS 345 is approximately 2.0 mm. Comparing the first line 551, the second line 552, and the third line 553, and the fourth line 504, it may be confirmed that a gain (hereinafter, a boresight gain) in a top side direction of the radiation pattern of the electronic device 101 decreases, as the distance between the radiator and the reflector becomes greater than approximately 0.1. For example, when the distance between the radiator and the reflector is approximately 2.0 mm apart, the boresight gain of the radiation pattern is approximately −0.3 dB lower than the boresight gain of the radiation pattern when the distance between the radiator and the reflector is approximately 1.0 mm apart. It may be confirmed that a role of the reflector decreases as the distance between the radiator and the reflector increases.

FIG. 6 illustrates an example of total efficiency according to a length of a metal structure (e.g., a metal structure 202 or SUS 345). The same reference numbers may be used for the same descriptions.

Referring to FIG. 6, a graph 600 indicates total efficiency according to the length of the metal structure (e.g., a metal structure 202 or SUS 345). A horizontal axis of the graph 600 is a frequency (unit: GHz) and a vertical axis of the graph 600 indicates total efficiency (unit: decibel, dB). The metal structure may correspond to a ground structure for an antenna (or a radiator). The length of the metal structure indicates a length of the metal structure in a direction (e.g., the x-axis direction in FIGS. 3A and 3B). For example, the direction may correspond to a longitudinal direction of a conductive portion (e.g., a conductive portion 212 or a second conductive portion 312). For example, the direction may correspond to a longitudinal direction of a conductive line (e.g., the conductive line 360) disposed closest to the metal structure among a radiation line portion (e.g., the radiation line portion 263). Based on the direction, a length of a region (e.g., a ground structure region 352) including the metal structure may be defined relative to a length of a region (e.g., an antenna structure region 351) including a conductive region surrounding a slit 325 where the conductive line 360 is positioned.

A first line 601 indicates total efficiency of an antenna using a metal structure having a length of approximately 1 mm shorter than a length of the antenna structure region 351 as a reflector. A second line 602 indicates total efficiency of an antenna using a metal structure having a length of approximately 2 mm shorter than a length of the antenna structure region 351 as a reflector. A third line 603 indicates total efficiency of an antenna using a metal structure having a length of approximately 5 mm shorter than a length of the antenna structure region 351 as a reflector. A fourth line 604 indicates total efficiency of an antenna using a metal structure having a length of approximately 8 mm shorter than a length of the antenna structure region 351 as a reflector. A fifth line 605 indicates total efficiency of an antenna using a metal structure having a length corresponding to a length of the antenna structure region 351 as a reflector.

Referring to the graph 600, it may be confirmed that a difference between total efficiency values between lines is within a threshold range at a frequency of approximately 2 GHz. For example, at the frequency of approximately 2 GHz, a difference between the largest total efficiency value and the smallest total efficiency value may be within approximately 0.1 dB. However, in an approximately 3.5 GHz band, it may be confirmed that a difference in the total efficiency values between the lines is outside the threshold range. For example, in the approximately 3.5 GHz band, the difference in the total efficiency values between the lines may be greater than the difference in the total efficiency values between the lines in the approximately 2 GHz band. Through this result, it may be confirmed that the length of the metal structure does not significantly affect directivity. In Addition, through this result, it may be confirmed that the length of the metal structure may affect performance in a specific band (e.g., a frequency band other than the a S-band for satellite communication) of a radiator (e.g., the second conductive portion 312) supporting multiple bands. The metal structure may be required to provide a sufficient ground for the antenna. According to an embodiment of the disclosure, based on a direction (e.g., an x-axis direction), a difference between the length of the antenna structure region 351 and the length of the ground structure region 352 may be less than a threshold distance (e.g., approximately 2 mm).

FIG. 7 illustrates an example of a radiation pattern according to a length of a metal structure (e.g., a metal structure 202 or SUS 345). The same reference numbers may be used for the same descriptions.

Referring to FIG. 7, an example 700 indicates a radiation pattern according to a difference between a length of an antenna structure region 351 and a length of a ground structure region 352. 0° indicates a front direction of an electronic device 101 and 180° indicates a rear direction of the electronic device 101. 90° on a left side indicates a top side of the electronic device 101 and 90° on a right side indicates a bottom side of the electronic device 101. A first line 701 indicates a radiation pattern when the difference between the length of the antenna structure region 351 and the length of the ground structure region 352 is approximately 1 mm. A second line 702 indicates a radiation pattern when the difference between the length of the antenna structure region 351 and the length of the ground structure region 352 is approximately 5 mm. A third line 703 indicates a radiation pattern when the difference between the length of the antenna structure region 351 and the length of the ground structure region 352 is approximately 8 mm. A fourth line 704 indicates a radiation pattern when the difference between the length of the antenna structure region 351 and the length of the ground structure region 352 is approximately 0 mm. Comparing the first line 701, the second line 702, the third line 703, and the fourth line 704, it may be confirmed that a change in a gain in a top side direction of the radiation pattern of the electronic device 101 is insignificant.

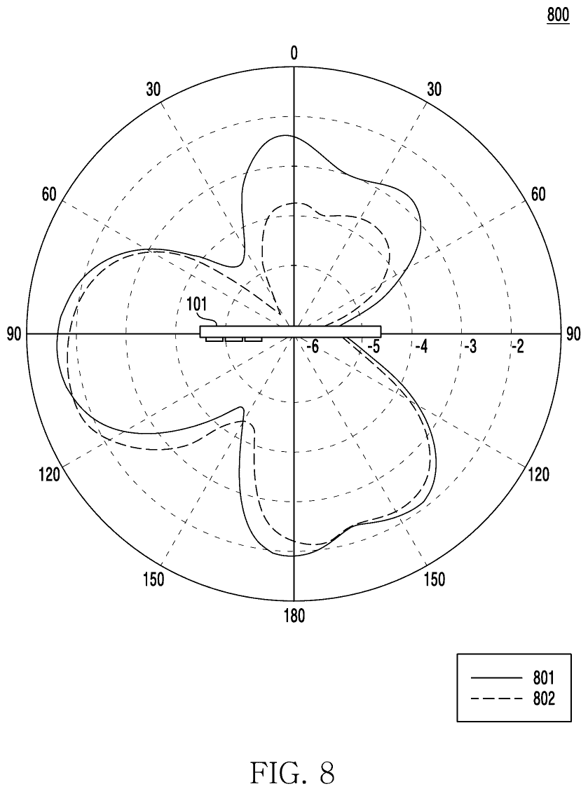

FIG. 8 illustrates an example of a radiation pattern of an antenna including a radiation line portion (e.g., a radiation line portion 263) adjacent to a metal structure (e.g., a metal structure 202, or SUS 345).

Referring to FIG. 8, an example 800 illustrates a radiation pattern according to presence or absence of the conductive line 360 of the radiation line portion 263 of FIG. 3B adjacent to the SUS 345. 0° indicates a front direction of an electronic device 101 and 180 ° indicates a rear direction of the electronic device 101. 90° on a left side indicates a top side of the electronic device 101 and 90° on a right side indicates a bottom side of the electronic device 101. A first line 801 indicates a radiation pattern in a structure in which the radiation line portion 263 (or the conductive line 360) is spaced apart from the SUS 345 by a distance within a predefined range (e.g., greater than or equal to approximately 0.5 mm and within 1.0 mm). A second line 802 indicates a radiation pattern in a feeding structure that does not include the radiation line portion 263 (or the conductive line 360) positioned within the predefined range from the SUS 345.

A gain in the top side direction of the radiation pattern of the electronic device 101 of the first line 801 may be approximately 36.0 decibel milliwatt (dBm). A gain in the top side direction of the radiation pattern of the electronic device 101 of the second line 802 may be approximately 34.8 dBm. Comparing the first line 801 and the second line 802, it may be confirmed that the gain in the top side direction of the radiation pattern of the electronic device 101 increases through a structure in which the radiation line portion 263 (or the conductive line 360) is spaced apart from the SUS 345 by the distance within the predefined range (e.g., greater than or equal to approximately 0.5 mm and within 1.0 mm).

Embodiments of the disclosure relate to a reflector antenna using an antenna (e.g., the antenna 201) and an electrical material (e.g., the metal structure 202). The reflector may be used to improve performance of the antenna by reflecting electromagnetic waves in a specific direction. A portion (e.g., the conductive line 360 of the radiation line portion 263) of the antenna 201 may be disposed adjacent to the electrical material, and the electrical material may function as a reflector for signals radiated from the portion. Accordingly, upper hemisphere directivity of the electronic device 101 may increase.

The effects that may be obtained from the disclosure are not limited to those described above, and any other effects not mentioned herein will be clearly understood by those having ordinary knowledge in the art to which the disclosure belongs, from the following description.

In embodiments of the disclosure, an electronic device 101 is provided. The electronic device 101 may comprise wireless communication circuitry 220, a metal frame including a conductive portion 212 or 312, and a circuit board 250 including a ground region 251 for the wireless communication circuitry 220 and a fill-cut region 253 formed between the ground region 251 and the conductive portion 212 or 312. The circuit board 250 may include a feeding portion 261 connected to the wireless communication circuitry 220 in the ground region 251 and a radiation line portion 263 extending from the feeding portion 261 in the fill-cut region 253 and connected to the conductive portion 212 or 312. The electronic device 101 may comprise a metal structure 202 or the SUS 345 configured to function as a reflector in response to signals from the radiation line portion 263. The radiation line portion 263 may include a conductive line having a longitudinal direction corresponding to a longitudinal direction of the conductive portion 212 or 312 between the metal structure 202 or the SUS 345 and the conductive portion 212 or 312.

For example, the radiation line portion 263 may be spaced apart from the metal structure 202 or the SUS 345 by a distance less than 1 millimeter (mm) substantially.

For example, the radiation line portion 263 may be spaced apart from the metal structure 202 or the SUS 345 by the distance greater than or equal to 0.5 mm substantially.

For example, at least a portion of the conductive portion 212 or 312 may be disposed, among a top side, a bottom side, a left side, and a right side of the electronic device 101, at the top side. The conductive line of the radiation line portion 263 may be formed apart from the metal structure 202 or the SUS 345 along one side of the metal structure 202 or the SUS 345 toward the top side of the electronic device 101.

For example, the metal frame may include a side structure forming an exterior side of the electronic device 101 and a support structure connected inward from the side structure. The side structure may include the conductive portion 212 or 312. The conductive portion 212 or 312 and the radiation line portion 263 connected to the conductive portion 212 or 312 may be used as a radiator for a frequency band for satellite communication.

For example, the side structure may include a second conductive portion 212 or 312 that is adjacent to a non-conductive portion 212 or 312 adjacent to the conductive portion 212 or 312. The side structure and the support structure may be connected through a plurality of connecting portions. The plurality of connecting portions may include a first connecting portion for the conductive portion 212 or 312 and a second connecting portion for the second conductive portion 212 or 312. The metal frame may have a slit formed between the first connecting portion, the second connecting portion, the conductive portion 212 or 312, the second conductive portion 212 or 312, and the support structure. In respect to the longitudinal direction of the conductive portion 212 or 312, a difference between a length of a conductive region surrounding the slit and a length of the metal structure may be less than 2 millimeter (mm) substantially.

For example, the conductive portion 212 or 312 may include a first protruding portion and a second protruding portion facing inward. The first protruding portion may be connected to a first signal path including the feeding portion 261 and the radiation line portion 263. The second protruding portion may be connected to a second signal path different from the first signal path. The first signal path may be used to transmit or receive signals in a frequency band for satellite communication through the conductive portion 212 or 312. The second signal path may be used to transmit or receive signals in a frequency band for cellular communication through the conductive portion 212 or 312.

For example, the support structure may include a third protruding portion formed to face the side structure. The third protruding portion may be disposed between the first protruding portion and the second protruding portion. The third protruding portion may be electrically connected to a ground portion of the circuit board 250.

For example, the circuit board 250 may include a first contact portion on which a first conductive member connected to the first protruding portion is disposed, and a first matching portion including one or more passive elements and disposed between the first contact portion and the radiation line portion 263. The first matching portion may be connected to a ground portion of the circuit board 250.

For example, the circuit board 250 may include a second feeding portion 261 connected to second wireless communication circuitry 220 for cellular communication in the ground region 251, a second contact portion on which a second conductive member connected to the second protruding portion is disposed and connected to the second feeding portion 261, and a second matching portion including one or more passive elements. The second matching portion may be connected to the ground portion of the circuit board 250.

For example, the ground region 251 may indicate a region having a ground plane above or below in the circuit board 250. The fill-cut region 253 may indicate a region having no the ground plane above or below in the circuit board 250.

For example, the metal structure 202 or the SUS 345 may comprise steel use stainless (SUS) for a speaker module of the electronic device 101.

For example, the metal structure 202 or the SUS 345 may comprise a camera bracket of the electronic device 101.

For example, within the electronic device 101, no ground structure may be disposed between the radiation line portion 263 and the metal structure 202 or the SUS 345.

For example, at least a portion of the radiation line portion 263 may be closest to the metal structure 202 or the SUS 345 among copper portions within the fill-cut region 253 of the circuit board 250.

In embodiments of the disclosure, an electronic device 101 is provided. The electronic device 101 may comprise wireless communication circuitry 220, a metal frame including a conductive portion 212 or 312, and a circuit board 250 including a feeding portion 261 connected to the wireless communication circuitry 220 and a radiation line portion 263 extending from the feeding portion 261 and connected to the conductive portion 212 or 312, and a metal structure 202 or the SUS 345 configured to function as a reflector in response to signals from the radiation line portion 263. The radiation line portion 263 may include a conductive line having a longitudinal direction corresponding to a longitudinal direction of the conductive portion 212 or 312 between the metal structure 202 or the SUS 345 and the conductive portion 212 or 312. The radiation line portion 263 may be spaced apart from the metal structure 202 or the SUS 345 by a distance greater than or equal to 0.5 millimeter (mm) and less than 1 mm substantially.

For example, at least a portion of the conductive portion 212 or 312 may be disposed, among a top side, a bottom side, a left side, and a right side of the electronic device 101, at the top side. The conductive line of the radiation line portion 263 may be formed apart from the metal structure 202 or the SUS 345 along one side of the metal structure 202 or the SUS 345 toward the top side of the electronic device 101.

For example, the metal frame may include a side structure forming an exterior side of the electronic device 101 and a support structure connected inward from the side structure. The side structure may include the conductive portion 212 or 312. The conductive portion 212 or 312, and the radiation line portion 263 connected to the conductive portion 212 or 312 may be used as radiator for a frequency band for satellite communication.

For example, the side structure may include a second conductive portion 212 or 312 that is adjacent to a non-conductive portion 212 or 312 adjacent to the conductive portion 212 or 312. The side structure and the support structure may be connected through a plurality of connecting portions. The plurality of connecting portions may include a first connecting portion for the conductive portion 212 or 312 and a second connecting portion for the second conductive portion 212 or 312. The metal frame may have a slit formed between the first connecting portion, the second connecting portion, the conductive portion 212 or 312, the second conductive portion 212 or 312, and the support structure. In respect to the longitudinal direction of the conductive portion 212 or 312, a difference between a length of a conductive region surrounding the slit and a length of the metal structure 202 or the SUS 345 may be less than 2 mm substantially.

For example, the metal structure 202 or the SUS 345 may comprise steel use stainless (SUS) for a speaker module.

In embodiments of the disclosure, an electronic device is provided. The electronic device may comprise wireless communication circuitry, a frame including a side structure forming an exterior lateral side of the electronic device and a support structure disposed inwardly from the side structure, wherein the side structure includes a conductive portion at a top lateral side of the electronic device, a circuit board including at least one insulator layer and at least one ground layer, wherein a feeding portion connected to the wireless communication circuitry is formed in a region 251 overlapping the at least one insulator layer and the at least one ground layer, a radiation line portion extending from the feeding portion and connected to the conductive portion is formed in a region 253, overlapping only the at least one insulator layer among the at least one insulator layer and the at least one ground layer, and a metal structure disposed over the support structure of the frame. The conductive portion and the radiation line portion connected to the conductive portion may be configured to function as a radiator. The metal structure may be configured to function as a reflector for signals from the radiation line portion. The radiation line portion may include a conductive line having a longitudinal direction corresponding to a longitudinal direction of the conductive portion between the metal structure and the conductive portion.

For example, the conductive line of the radiation line portion may be spaced apart from the metal structure and may be formed along one side of the metal structure toward the top lateral side of the electronic device.

For example, the conductive line of the radiation line portion may be spaced apart from the metal structure by a distance less than 1 millimeter (mm) substantially.

For example, the conductive line of the radiation line portion may be spaced apart from the metal structure by the distance greater than or equal to 0.5 mm substantially.

For example, the conductive portion and the radiation line portion connected to the conductive portion may be configured to transmit signals on a frequency band for satellite communication.

For example, the side structure may include a second conductive portion that is adjacent to a non-conductive portion adjacent to the conductive portion. A plurality of connecting portions may be disposed between the side structure and the support structure. The plurality of connecting portions may include a first connecting portion for the conductive portion and a second connecting portion for the second conductive portion. The frame may have a slit formed between the first connecting portion, the second connecting portion, the conductive portion, the second conductive portion, and the support structure. In respect to the longitudinal direction of the conductive portion, a difference between a length of a conductive region surrounding the slit and a length of the metal structure may be less than 2 millimeter (mm) substantially.

For example, the wireless communication circuitry may be used for satellite communication. The circuit board may include a second feeding portion connected to second wireless communication circuitry for cellular communication, a second contact portion on which a second conductive member connected to the second protruding portion is disposed and connected to the second feeding portion, and a second matching portion including one or more passive elements. The second matching portion may be connected to the ground portion of the circuit board.

For example, the region 251 overlapping the at least one insulator layer and the at least one ground layer may indicate a region having a ground plane above or below in the circuit board. The region 253 overlapping only the at least one insulator layer among the at least one insulator layer and the at least one ground layer may indicate a region having no ground plane above or below in the circuit board.

For example, at least a portion of the radiation line portion may be closest to the metal structure among copper portions within the region 253 overlapping only the at least one insulator layer among the at least one insulator layer and the at least one ground layer of the circuit board.

For example, the region 253 overlapping only the at least one insulator layer among the at least one insulator layer and the at least one ground layer may be positioned outside the region 251 overlapping the at least one insulator layer and the at least one ground layer.

In embodiments of the disclosure, an electronic device is provided. The electronic device may comprise wireless communication circuitry, a frame including a side structure forming an exterior lateral side of the electronic device and a support structure disposed inwardly from the side structure, wherein the side structure includes a conductive portion at a top lateral side of the electronic device, a circuit board including a feeding portion connected to the wireless communication circuitry and a radiation line portion extending from the feeding portion and connected to the conductive portion, and a metal structure configured to function as a reflector for signals from the radiation line portion. The radiation line portion may include a conductive line having a longitudinal direction corresponding to a longitudinal direction of the conductive portion between the metal structure and the conductive portion. The conductive line of the radiation line portion may be spaced apart from the metal structure by a distance greater than or equal to 0.5 millimeter (mm) and less than 1 mm substantially.

For example, the conductive portion and the radiation line portion connected to the conductive portion may be used as a radiator for a frequency band for satellite communication.

For example, the metal structure 202 comprises a camera bracket of the electronic device 101.

For example, within the electronic device 101, no ground structure may be disposed between the radiation line portion 263 and the metal structure 202 or the SUS 345.

For example, at least a portion of the radiation line portion 263 is closest to the metal structure 202 among copper portions within a region overlapping only at least one insulator layer among the at least one insulator layer and at least one ground layer of the circuit board.

For one or more embodiments of the disclosure, at least one of components described in one or more of preceding drawings may be configured to perform one or more operations, techniques, processes and/or methods as described in the disclosure. For example, a processor (e.g., a baseband processor) described in the disclosure in relation to one or more of the preceding drawings may be configured to operate according to one or more examples described in the disclosure. For another example, circuitry related to user equipment (UE), a base station, a network element, and the like, as described above in relation to one or more of the previous drawings, may be configured to operate according to the one or more examples described here.

Any of the embodiments described above may be combined with any other embodiments (or a combination of an embodiment) unless otherwise explicitly stated. The above-described description of one or more implementations provides examples and description, but is not intended to limit or tighten a scope of the embodiment in a precise form disclosed. Modification and deformation may be made in light of the above teachings or may be obtained from practice of various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
wireless communication circuitry;
a frame including a side structure forming an exterior lateral side of the electronic device and a support structure disposed inwardly from the side structure, the side structure including a conductive portion at a top lateral side of the electronic device;
a circuit board including at least one insulator layer and at least one ground layer,
wherein a feeding portion connected to the wireless communication circuitry is formed in a region overlapping the at least one insulator layer and the at least one ground layer, and
wherein a radiation line portion extending from the feeding portion and connected to the conductive portion is formed in a region, overlapping only the at least one insulator layer among the at least one insulator layer and the at least one ground layer; and
a metal structure disposed over the support structure of the frame,
wherein the conductive portion and the radiation line portion connected to the conductive portion are configured to function as a radiator,
wherein the metal structure is configured to function as a reflector for signals from the radiation line portion, and
wherein the radiation line portion includes a conductive line that is disposed between the metal structure and the conductive portion and has a longitudinal direction corresponding to a longitudinal direction of the conductive portion.

2. The electronic device of claim 1, wherein the conductive line of the radiation line portion is spaced apart from the metal structure and is formed along one side of the metal structure toward the top lateral side of the electronic device.

3. The electronic device of claim 1, wherein the conductive line of the radiation line portion is spaced apart from the metal structure by a distance being less than 1 millimeter (mm) substantially.

4. The electronic device of claim 3, wherein the conductive line of the radiation line portion is spaced apart from the metal structure by the distance being greater than or equal to 0.5 mm substantially.

5. The electronic device of claim 1, wherein the conductive portion and the radiation line portion connected to the conductive portion are configured to transmit signals on a frequency band for satellite communication.

6. The electronic device of claim 1,
wherein the side structure further includes a second conductive portion that is adjacent to a non-conductive portion adjacent to the conductive portion,
wherein a plurality of connecting portions are disposed between the side structure and the support structure,
wherein the plurality of connecting portions include a first connecting portion for the conductive portion and a second connecting portion for the second conductive portion,
wherein the frame has a slit formed between the first connecting portion, the second connecting portion, the conductive portion, the second conductive portion, and the support structure, and
wherein, in respect to the longitudinal direction of the conductive portion, a difference between a length of a conductive region surrounding the slit and a length of the metal structure is less than 2 millimeter (mm) substantially.

7. The electronic device of claim 1,
wherein the conductive portion includes a first protruding portion and a second protruding portion facing inward,
wherein the first protruding portion is connected to a first signal path including the feeding portion and the radiation line portion,
wherein the second protruding portion is connected to a second signal path different from the first signal path,
wherein the first signal path is used to transmit or receive signals in a frequency band for satellite communication through the conductive portion, and
wherein the second signal path is used to transmit or receive signals in a frequency band for cellular communication through the conductive portion.

8. The electronic device of claim 7,
wherein the support structure includes a third protruding portion formed to face the side structure,
wherein the third protruding portion is disposed between the first protruding portion and the second protruding portion, and
wherein the third protruding portion is electrically connected to a ground portion of the circuit board.

9. The electronic device of claim 7,
wherein the circuit board includes:
a first contact portion on which a first conductive member connected to the first protruding portion is disposed, and
a first matching portion including one or more passive elements and disposed between the first contact portion and the radiation line portion, and
wherein the first matching portion is connected to a ground portion of the circuit board.

10. The electronic device of claim 9,
wherein the wireless communication circuitry is used for satellite communication,
wherein the circuit board includes:
a second feeding portion connected to second wireless communication circuitry for cellular communication,
a second contact portion on which a second conductive member connected to the second protruding portion is disposed and connected to the second feeding portion, and
a second matching portion including one or more passive elements, and
wherein the second matching portion is connected to the ground portion of the circuit board.

11. The electronic device of claim 1,
wherein the region overlapping the at least one insulator layer and the at least one ground layer indicates a region having a ground plane above or below in the circuit board, and
wherein the region overlapping only the at least one insulator layer among the at least one insulator layer and the at least one ground layer indicates a region having no ground plane above or below in the circuit board.

12. The electronic device of claim 1, wherein the metal structure comprises steel use stainless (SUS) for a speaker module of the electronic device.

13. The electronic device of claim 1, wherein the metal structure comprises a camera bracket of the electronic device.

14. The electronic device of claim 1, wherein, within the electronic device, no ground structure is disposed between the radiation line portion and the metal structure.

15. The electronic device of claim 1, wherein at least a portion of the radiation line portion is closest to the metal structure among copper portions within the region overlapping only the at least one insulator layer among the at least one insulator layer and the at least one ground layer of the circuit board.

16. An electronic device comprising:
wireless communication circuitry;
a frame including a side structure forming an exterior lateral side of the electronic device and a support structure disposed inwardly from the side structure, the side structure including a conductive portion at a top lateral side of the electronic device;
a circuit board including a feeding portion connected to the wireless communication circuitry and a radiation line portion extending from the feeding portion and connected to the conductive portion; and
a metal structure configured to function as a reflector for signals from the radiation line portion,
wherein the radiation line portion includes a conductive line having a longitudinal direction corresponding to a longitudinal direction of the conductive portion between the metal structure and the conductive portion, and
wherein the conductive line of the radiation line portion is spaced apart from the metal structure by a distance greater than or equal to 0.5 millimeter (mm) and less than 1 mm substantially.

17. The electronic device of claim 16,
wherein at least a portion of the conductive portion is disposed, among a top side, a bottom side, a left side, and a right side of the electronic device, at the top side, and
wherein the conductive line of the radiation line portion is formed apart from the metal structure along one side of the metal structure toward the top side of the electronic device.

18. The electronic device of claim 16, wherein the conductive portion and the radiation line portion connected to the conductive portion are used as a radiator for a frequency band for satellite communication.

19. The electronic device of claim 16,
wherein the side structure further includes a second conductive portion that is adjacent to a non-conductive portion adjacent to the conductive portion,
wherein the side structure and the support structure are connected through a plurality of connecting portions,
wherein the plurality of connecting portions include a first connecting portion for the conductive portion and a second connecting portion for the second conductive portion,
wherein the frame has a slit formed between the first connecting portion, the second connecting portion, the conductive portion, the second conductive portion, and the support structure, and
wherein, in respect to the longitudinal direction of the conductive portion, a difference between a length of a conductive region surrounding the slit and a length of the metal structure is less than 2 mm.

20. The electronic device of claim 16, wherein the metal structure comprises steel use stainless (SUS) for a speaker module of the electronic device.
